(19) United States
(12) Patent Application Publication
(10) Pub. No.: US 2014/0244252 A1
(43) Pub. Date: Aug. 28, 2014

(54) METHOD FOR PREPARING A TRANSCRIPT OF A CONVERSION

(71) Applicants: John Dines, Lausanne (CH); Philip Garner, Martigny (CH); Thomas Hain, Cambridge (GB); Temitope Ola, Sion (CH)

(72) Inventors: John Dines, Lausanne (CH); Philip Garner, Martigny (CH); Thomas Hain, Cambridge (GB); Temitope Ola, Sion (CH)

(73) Assignee: Koemei SA, Martigny (CH)

(21) Appl. No.: 14/128,357

(22) PCT Filed: Jun. 20, 2012
(86) PCT No.: PCT/EP2012/061838

§ 371 Date: Apr. 11, 2014

(30) Foreign Application Priority Data
Jun. 20, 2011 (CH) 1041/11

(51) Int. Cl. G10L 15/26

(52) U.S. Cl. CPC G10L 15/26
USPC 704/235

(57) ABSTRACT

A method for providing participants to a multiparty meeting with a transcript of the meeting, comprising the steps of: establishing an meeting among two or more participants; exchanging during said meeting voice data as well as documents; uploading at least a part of said voice data and at least a part of said documents to a remote speech recognition server (1), using an application programming interface of said remote speech recognition server; converting at least a part of said voice data to text with an automatic speech recognition system (13) in said remote speech recognition server, wherein said automatic speech recognition system uses said documents to improve the quality of speech recognition; building in said remote speech recognition server a computer object (120) embedding at least a part of said voice data, at least a part of said documents, and said text; making said computer object (120) available to at least one of said participant.

### FIELD OF THE INVENTION

The present invention concerns a method for preparing a transcript of a conversation. In one embodiment, the present invention is related to a method for providing participants to a meeting and other parties, with a transcript of the meeting, such as for example an online meeting.

### DESCRIPTION OF RELATED ART

A teleconference enables any number of participants to hear and be heard by all other participants to the teleconference. Accordingly, a teleconference enables participants to meet and exchange voice information without being in face-to-face contact. Telephone conference systems have been described and proposed by various telecommunication operators, often using a centralized system where a central teleconferencing bridge in the telecommunication network infrastructure receives and combine voice signals received from different lines, and distributes the combined audio signal to all participants.

In Proc. Interspeech 2010, Tokyo, 2010, “The AMIDA 2009 Meeting Transcription System”, the content of which is hereby enclosed by reference, Thomas Hain et al. describe various methods for speech recognition of meeting speech. Those methods could be used for processing multichannel audio data output by a teleconference system.

Online meeting systems are also known in which a plurality of participants to the meeting are connected over an online network, such as an IP network. Online meeting systems offer various advantages over teleconference systems, such as the ability to exchange not only voice but also video and documents between all participants to an online meeting. Online meeting software solutions have been proposed by, without limitation, Cisco Webex, Adobe Connect, Citrix GoToMeeting, GoToWebinar etc (all trademarks of the respective companies).

Online meeting solutions are often distributed and based on software installed in an equipment, such as a PC, of each participant. This software is used for acquisition and restitution of voice and video from each participant, and for combining, encoding, transmitting over the IP network, and decoding this voice and video in order to share it with all participants. Usually, online meeting solutions further allow exchange of other documents during the meeting, such as without limitation slides, notes, word processing documents, spreadsheets, pictures, videos, etc. Online meeting could also be established using applications running in an Internet browser of the participant.

FIG. 1 illustrates an example of interface of such an online meeting software run by a user equipment 4. In the figure, frame 44 designates an area where documents shared by all participants are displayed. Frame 45 is an area where the list of participants to the online meeting is displayed, often with the name and a fixed or video image of each participant. For example, a video of each participant can be taken with a webcam of his equipment, and displayed to all other participants. Frame 46 is a directory with a list of documents which can be shared and displayed to the other participants. Those different frames can be displayed within a browser or by a dedicated application. The application or a plug-in working with the browser selects the document which should be displayed to all participants, and is responsible for acquisition, combining, encoding, transmitting, decoding and restitution of the voice and video signals captured in each participant's equipment.

The use of speech recognition software for providing participants to an online meeting with a text transcript of the online meeting has been described in U.S. Pat. No. 6,816,468B1. This document describes a method where the transcription of the voice into text is performed by the teleconference server, and/or distributed between a participant's computer and a teleconference bridge server. This solution thus requires a teleconference server, and is not adapted to decentralized online meeting solutions based on peer-to-peer exchange of multimedia data without any central server for establishing the teleconference.

Therefore, there is a need in the prior art for a method for providing participants to a meeting, such as for example an online meeting, with a transcript of the meeting, where the method does not require a central teleconference server for establishment of the teleconference.

Furthermore, existing speech recognition software used for the transcription of online meetings and teleconferences are usually provided by the same provider who also offers the online meeting solution, and embedded in the software package proposed by this provider. A participant or group of participants who are unhappy with the quality of speech recognition, or who for any reason would like to use a different speech recognition solution, are usually prevented from changing the speech recognition solution, or have to replace the whole online meeting software.

Therefore, there is a need for a method for providing participants to a meeting, such as for example an online meeting, with a transcript of the meeting which can be provided by any provider of text-to-speech recognition, independently of the provider of the online meeting software, and independently of whether this software is based upon central bridge or peer-to-peer technology.

US2010/268534 describes a method and a solution in which each user has a personal computing device with a personal speech recognizer for recognizing the speech of this user as recognized text. This recognized text is merged into a transcript with other texts received from other participants in a conversation. This solution thus requires from each user to install and maintain a personal speech recognizer. Moreover, each user is dependent on the availability and quality of the speech recognizer installed by other participants; if one of the participants has no speech recognizer, or a poor-performing or slow speech recognizer, all other participants to the meeting will received an incomplete, bad-quality, and/or delayed transcript. Therefore, this solution is poorly adapted to a provider of online meeting solutions who wants to offer text-to-speech transcription to all participants, because this solution would require the installation and deployment of speech recognizers in equipments of all users.

Moreover, in this solution, documents which may be sent by an user during a meeting, or received by this user, are apparently not used by the speech recognizer. It is not clear either whether those documents will be part of the transcript sent to each participant. Therefore, words or expressions which are unknown by the speech recognizer, or known but associated with a low probability of being spoken, will not be recognised even if those words or expressions are present in documents exchanged between participants during the conference.

It has also been observed that speech recognition during a teleconference or other types of meetings is a very difficult task, because different participants often speak simultaneously, often use different type of equipment, and speak in different ways or with different accents. In particular, some speech recognition solution which are very effective for the recognition of voice from a single user, or even for phone conferences between two participants, have been found to be almost useless for the transcription of voice during multiparty meetings, such as online meetings.

Therefore, there is a need for a method for providing participants to a meeting, such as for example an online meeting, with a better transcript of the meeting.

It has also been found that in many teleconference and other meeting events, several participants share a single piece of equipment. For example, it is quite common in videoconference or telepresence meetings to bring together groups of participants in one meeting room equipped with the appropriate teleconferencing equipment, and exchange voice, video and documents with other participants or groups of participants at remote locations. Existing solutions for providing participants to a meeting are often poorly adapted to those settings where a plurality of participants share the teleconferencing equipment.

Another aim of the invention is to obviate or mitigate one or more of the aforementioned disadvantages.

### BRIEF SUMMARY OF THE INVENTION

According to a first aspect of the invention, there is provided a method for providing participants to a multiparty meeting with a transcript of the meeting, comprising the steps of:

establishing an meeting among two or more participants;

exchanging voice data as well as documents during said meeting;

uploading at least a part of said voice data and at least a part of said documents to a remote speech recognition server, using an application programming interface of said remote speech recognition server;

converting at least a part of said voice data to text with an automatic speech recognition system in said remote speech recognition server, wherein said automatic speech recognition system uses said documents to improve the quality of speech recognition;

building in said remote speech recognition server a computer object embedding at least a part of said voice data, at least a part of said documents, and said text;

making said computer object available to at least one of said participant.

As the automatic speech recognition (ASR) is run on a remote speech recognition server, it can be operated independently of the software used for the establishment of the online meeting. The remote speech recognition server provides an application programming interface (API) which can be used by the online meeting software when the meeting software requires a transcription of a multiparty meeting. Thus, a plurality of different speech recognition systems can be used by a meeting server, and a single speech recognition system can be used with different meeting software. Moreover, this solution does not require from each user or participant to install and maintain his own personal speech recognizer.

The API interface of the remote speech recognition server could also be used by other applications in the participants' equipments, including equipments for recording face-to-face meetings. Thus, the solution is not restricted to online meetings only, but could be used for providing a transcript of other types of multiparty meetings.

The meeting can be recorded and the transcript prepared after the meeting. Alternatively, the transcription can be initiated and possibly even terminated during the meeting.

The conversion into text can be entirely automatic, i.e., without any user-intervention, or semi-automatic, i.e., prompting a user to manually enter or verify the transcription of at least some words or other utterances.

The remote speech recognition server provides a single object which encapsulates different attributes corresponding to voice, video and documents shared between participants during the meeting, as well as the transcript of the audio portion of the meeting. The transcript may include not only recognized text, but also additional information or metadata that has been automatically extracted, including for example timing associated with different portions of the text, identification and location of the various speakers (participants), non-speech events, confidences, word/phone lattices etc.

This object preferably includes methods for editing and completing those attributes, as well as methods for triggering the speech to text transcription. The methods could also trigger other processing: eg. generate summary, export/publish (to a word processing software, video sharing online platform, social network etc), share with other parties (participants/non-participants). The object may also keep track of where the object has been exported to (in case of web sites or pages of a social network) and may also use this information to improve the automatic speech recognition, for example by including words and expressions from this web site in its vocabulary.

The object may also be associated with one or a plurality of workflows (or have a default workflow) that would include both automatic (machine) and manual (human) interactions.

The object may be stored in a server, or in “the cloud”, i.e., in a virtual server in the Internet.

Therefore, any developer or user of an online meeting software has access to a single object with which he can retrieve any data related to the meeting, and manipulate this data.

The remote speech recognition server could be a single server, for example embodied as a single piece of hardware at a defined location. The remote speech recognition server could also be a cluster of distributed machines, for example in a cloud solution. Even if the remote speech recognition server is in a cloud, his installation is preferably under the responsibility of a single entity, such as a single company or institution, and does not require authorization by any participating user.

Computer objects as such are known in the field of computer programming. For example, in the context of MPEG-7, multimedia content can be described by objects embedding the video, audio and/or data content, as well as methods for manipulating this content. In the context of object-oriented programming, an object refers to a particular instance of a class, and designates a compilation of attributes (such a different types of data, including for example video data, audio data, text data etc) and behaviors (such as methods or routines for manipulating those attributes).

According to another aspect of the invention, the audio, video and other document produced during a meeting are preferably packaged into a single editable computer object. Editing of this object at a later stage, after the first speech recognition, is used for iteratively improving the speech recognition. For example, edition of this object by one participant causes an adaptation of the speech and/or language models, and a new run of the automatic speech recognition system with those adapted models. Therefore, the quality of the transcript is iteratively and collaboratively improved each time a user edits or completes the documents in an object associated with an online meeting.

According to one aspect of the invention, words and/or sentences in any document shared between participants during the meeting are used for augmenting a vocabulary used by the automatic speech recognition system. Those words can also be used for adapting the language models used by the automatic speech recognition system, including for example the probability of those words or sentences or portions of sentences to have been uttered during a given meeting and/or by a given participant. Therefore, a word or a sentence or a portion of sentence which is present, or often present, in one document associated with the online meeting is more likely to be selected by the automatic speech recognition system than a word or sentence or portion of sentence which is absent from all those documents.

According to one aspect of the invention, the automatic speech recognition system performs a multipass speech recognition, i.e. a recognition method where the text transcript delivered by the first pass is used for adapting the automatic speech recognition system, and where the adapted automatic speech recognition systems used during a subsequent pass for recognizing the same voice material. Alternatively, parallel passes could be used where different recognition configurations (including different adaptations) are run in parallel and their output combined at the end.

Speech and/or language used during successive and/or parallel passes are adapted. For example, a word which is recognised with a high confidence level during a first pass will be used to adapt the language model, and thus increase the probability that this word will be correctly recognised in a different portion of the voice signal during a subsequent pass. This is especially useful when for example the voice of one speaker can be recognised with a high confidence level during an initial, and used during at least one subsequent pass for improving the recognition of other speakers who are likely to use the same or a similar vocabulary.

According to one aspect of the invention, the participants can modify or complete the computer objects produced by the automatic speech recognition system at any time after the online meeting. For example, one participant can associate new documents with a meeting, such as new slides, notes or new text documents, and/or correct documents, including the transcript of the online meeting. Those additions and corrections can then be used by the automatic speech recognition system to trigger a new conversion of the voice data to text, and/or for adapting the speech and/or language models used by the automatic speech recognition system.

According to one aspect of the invention, a participant-dependant lexicon, and language models, and acoustic models, are built, based at least in part on documents provided by said participant, or by any other party, and used for performing the automatic speech recognition of the voice of this participant. Therefore, different speech and/or language models can be used by the automatic speech recognition system for recognising the speech of different participants to a same meeting.

According to one aspect of the invention, meeting dependant acoustic and/or language models are built or adapted based on documents provided during said meeting, or provided by any party at any time, and used for performing the automatic speech recognition. Therefore, different speech and/or language models can be used by the automatic speech recognition system for speech recognition during different meetings; the recognition of voice from one user will then depend on the meeting, since one user could speak in a different way and use different language in different meetings.

According to one aspect of the invention, the online meeting is classified into at least one class among several classes. Latent variables could also be used, where a meeting is considered a probabilistic combination of several classes of meeting. The classification depends on the topic or style of a meeting as determined from the documents and/or from the transcript. Lexica, language and acoustic models are then selected or created on the basis of this class, and used for performing the automatic speech recognition.

According to one aspect of the invention, user-authorisations are embedded into said objects for determining which users are authorized to read and/or modify which attribute of the objects. For example, a power user may be authorised to edit the transcript of the meeting, whereas a normal user might only have a right to read this transcript. User-authorisations may also define right to share or view documents, or any other access control.

According to one aspect of the invention, a speaker identification method is used for identifying which participant is speaking at each instant. This speaker identification may be based on the voice of each participant, user speaker identification technology. Alternatively, or in addition, the speaker identification might be based on an electronic address of the participant, for example on his IP address, on his login, on his mac address etc. Alternatively, or in addition, the speaker identification might be based on information provided by an array of microphone and a beamforming algorithm for determining the location of each participant in a room, and distinguishing among several participants in the same room. Alternatively, a participant can identify himself or other participant during the meeting, or during subsequent listening of the meeting.

In one aspect, the beamforming is adapted based on the documents and/or on the transcript. For example, speaker identification might be initially performed with a non-adapted beamforming system in order to distinguish among several participants in a single room.

An additional aspect would be the ability of the object to be stored locally as well as at the server side, in one or several passes, thereby giving the user the ability to work with the object while not connected to the Internet. Necessary functionality would include the ability to synchronise remote and locally stored versions of the object and mechanisms to resolve versioning issues if the object has been modified by two parties simultaneously.

### BRIEF DESCRIPTION OF THE DRAWINGS

The invention will be better understood with the aid of the description of an embodiment given by way of example and illustrated by the figures, in which:

FIG. 1 is a screen copy of the display of an online meeting software.

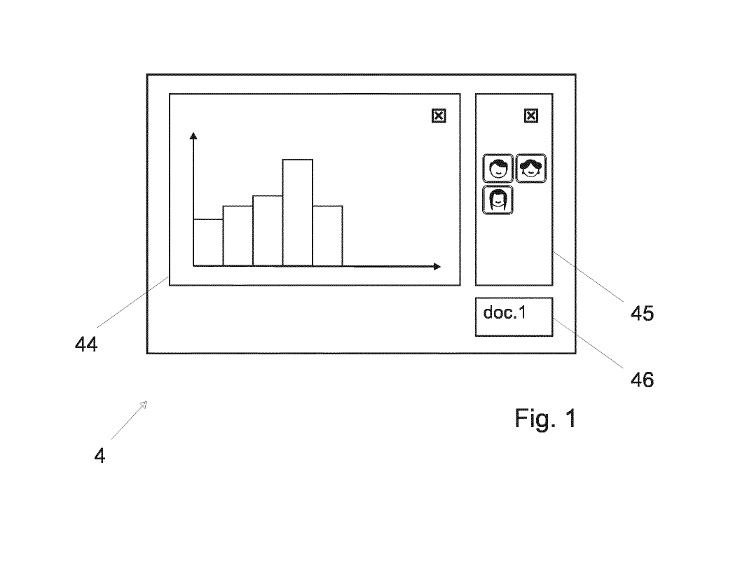

FIG. 2 is a block diagram of a system allowing participants to establish an online meeting and to receive a transcript of the teleconference.

FIG. 3 is a call-flow diagram illustrating a call-flow for serving transcription services to an online meeting participant.

FIG. 4 is a block diagram illustrating a multipass speech recognition.

FIG. 5 is a block diagram of a system allowing a plurality of participants in a single room to be distinguished and identified during an online meeting.

### DETAILED DESCRIPTION OF POSSIBLE EMBODIMENTS OF THE INVENTION

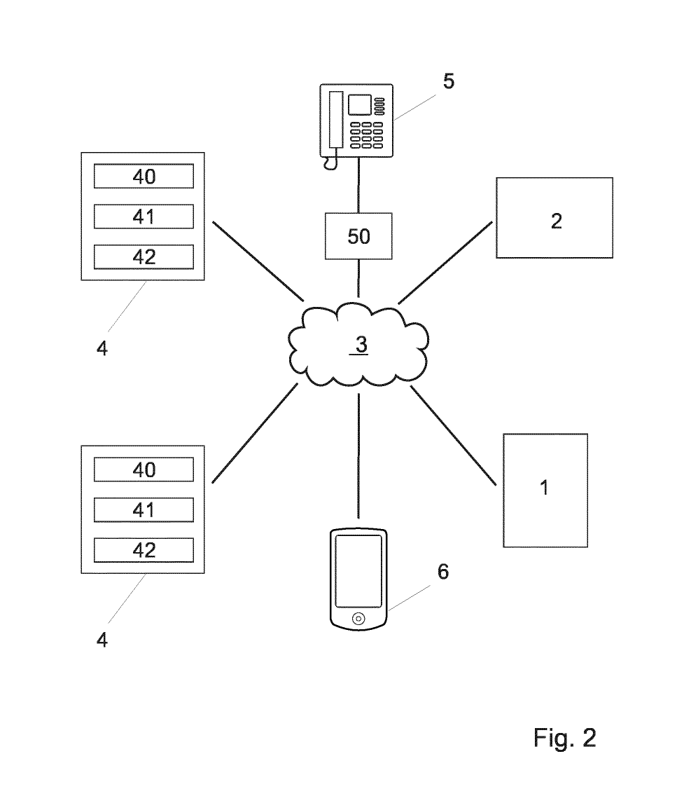

FIG. 2 is a block diagram of a system allowing a plurality of participants to establish an online meeting over an IP network 3, such as the Internet. Participants are using an online meeting software such as without limitation Cisco Webex, Adobe Connect, Citrix GoToMeeting, GoToWebinar etc (all trademarks of the respective companies). An online meeting could also be established over a browser without any dedicated software installed in the participant's equipment. Each participant has on online equipment 4 comprising a display 40, an IP telephone 41 and a processing system 42 for running this online meeting software. User equipments could be, for example, a personal computer, a tablet PC 6, a smartphone, a PDA, a dedicated teleconference equipment, or any suitable computing equipment with a display, microphone, Internet connection and processing capabilities. At least some of the equipment may have a webcam or other image acquisition components. Some participants 5 could participate to the online meeting with less advanced equipment, such as a conventional telephone 5, a mobile phone, etc; in this case, a gateway 50 is provided for connecting those conventional equipments to the IP network 3 and converting the phone signals into IP telephony data streams.

The online meeting can be established in a decentralized way, using online meeting software installed in user equipment 4 mutually connected so as to build a peer-to-peer network. Alternatively, an optional central teleconference or online meeting server 2 can be used for providing additional services to the participants, and/or for connecting equipment 5 that lack the required software and functionalities.

The system of the invention further comprises a remote collaborative automatic speech recognition (ASR) server 1 which can be used and accessed by the various participants, and optionally by the central online meeting server 2, for converting speech exchanged during online meetings into a text transcript, and for storing objects embedding the content of online meetings.

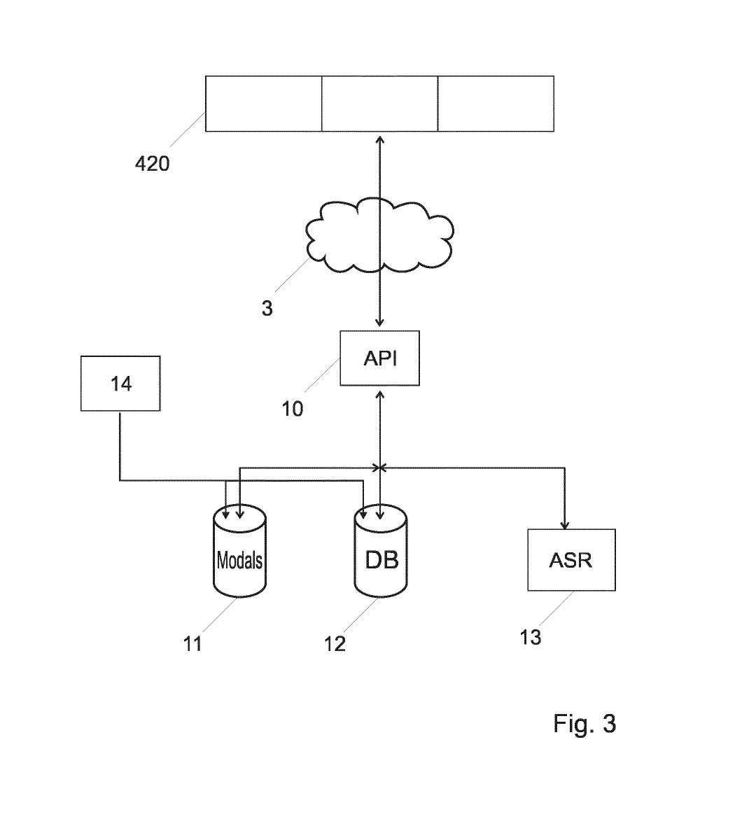

The architecture of a possible automatic speech recognition server 1 is illustrated on FIG. 3. It comprises a first application programming interface (API) 10 which can be used by various and different online meeting software run in different equipment in order to provide speech transcription services as well as a repository for online meeting documents and streaming of data. The core of the automatic speech recognition server is an automatic speech recognition system 13, for example a multipass system based on Hidden Markov Models, Neural networks or a Hybrid of the two, in order to provide for transcription of speech exchanged during online meeting into text made available to the participants. The speech recognition can use for example methods described by Thomas Hain et al. describe in “The AMIDA 2009 Meeting Transcription System.

The automatic speech recognition server 1 can be a centralized server or set of servers, as in the illustrated embodiment. The automatic speech recognition server, or some modules of this server, can also be a virtual server, such as a decentralized set of servers and other computer equipment, for example a cluster of decentralized, distributed machines connected over in the Internet, in a cloud configuration. For the sake of simplicity, when we use the word “server” in this description, one should understand either a central server, a set of central servers, or a cluster of servers/equipments in a cloud configuration.

The speech recognition uses speech and language models stored in a database 11. In a preferred embodiment, the database 11 includes at least some speech and/or language models which are:
Speaker (or participant) dependent; and/or
Meeting dependent; and/or
Topic dependent; and/or
Industry/Sector dependent.

Long-term adaptations of the models could be performed for incrementally improving their performance. Additionally, dynamic adaptations could be performed for improving performance on a specific recording or series of recordings. The adaptation might also be dependant on the input/recording device, and/or on the recording environment (office, studio, car, . . . )

The automatic speech recognition system2 can also comprise a module (not shown) for identifying the participant, based for example on his voice, on his electronic address (IP address, mac address, or login name) as indicated as parameter by the software which invokes the API 10, on indication provided by the participants themselves during or after the online meeting, and/or on the location of the participant in the room as determined with a beamforming module, as will be described. The automatic speech recognition system 2 can also comprise a classifier (not shown) for classifying each meeting into one class among different classes, depending on the topic of the meeting as determined from a text analysis of the documents and/or transcript of the meeting.

The element 14 is a second application programming interface (API) for manipulating the models in database 11, as well as possibly for database operation on the database 12. While the API 10 is optimized for numerous, fast, relatively low-volume operations in order to create and manipulate each individual meeting object, the API 14 is more optimized for less frequent manipulation of large amount of data in databases 10 and 14. For example, API 14 can be used for adapting, augmenting or replacing of speech or language models.

Reference 12 is a database within server 2 in which data related to different meetings are stored. Example of data related to a meeting include for example the voice content, the video content, various documents such as slides, notes, text, spreadsheets, etc exchanged between participants during or after the meeting, as well as the transcript of the meeting provided by the automatic speech recognition system 13. Each meeting is identified by an identifier (or handle) with which it can be accessed. All data related to a meeting is embedded into a single computer object, wherein the attributes of the object correspond to the various types of data (voice, video, transcript, document, metadata, etc) and wherein different methods are made available in order to manipulate those attributes. In this object, the audio, video and document contribution from each participant is preferably distinguished; it is thus possible to retrieve later what has been said and shown by each participant.

It is also possible to store relationships between different objects—eg. a series of meetings related to a single project or a team of individuals that works together frequently. This information can likewise be used to improve the automatic speech recognition.

It has to be noted that items associated with an online meeting object do not need to be physically stored in server 12. For instance, audio, video and/or documents uploaded by participants may be on their own filespace or on a different server. In this case, database 12 only stores a pointer, such as a link, to those items.

The API 10 provides methods allowing online meeting software 420 of various providers and in various equipments to upload data relating to different online meetings. For example, the audio, video and document content related to a meeting can be uploaded during or after the online meeting by any participant, and/or by a central online meeting server 2. The API may for example be called during establishment of the online meeting and receive input, such as multi-channel audio- and video data, documents and metadata from all participants during the meeting. Alternatively, this content can be stored in one or several of the user equipment, and transmitted to the API 10 at a later stage during or after the online meeting. The transmission of online meeting data the API 10 can be automatic, i.e., without explicit order from the participant, or triggered by one participant.

The API 10 further comprises methods for performing a speech-to-text transcription of the audio content of a meeting. The speech-to-text conversion can be initiated automatically each time that a voice file is uploaded into database 12, or initiated by a participant or participant's software over the API 10. The result of this conversion, i.e., the transcript of the meeting, is stored into database 10 and made accessible to the participants. The contribution of each participant to this transcript is distinguished, using speaker or participant identification methods.

The API 10 further comprises methods for downloading objects, or at least some attributes of those objects, from database 12 into the equipment of a participant. For example, a method can be used for retrieving the previously computed transcript of a meeting. Another method can be used for retrieving the previously stored audio, video, or document content corresponding to an online meeting.

Other methods might be provided in API 10 for searching objects corresponding to particular meetings, editing or correcting those objects, modifying the rights associated with those objects, etc.

The objects in database 12 might be associated with user rights. For example, a particular object might be accessible only by participants to a meeting. Even among those participants, some might have more limited rights; for example, some participants might be authorized to edit a transcript or to add or modify existing documents, while other participants might have read-only rights only.

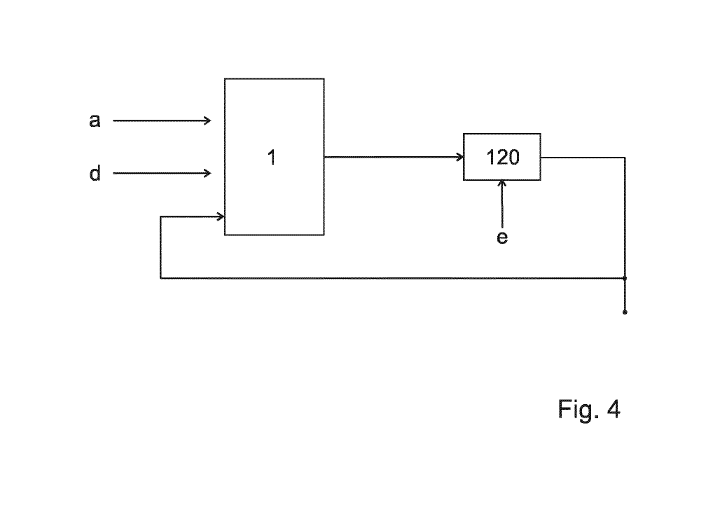

The speech recognition performed by the ASR system 13 can operate in one or multiple passes, as illustrated by FIG. 4. The audio content is input along with the documents d to the automatic speech recognition system 1, which outputs a first transcript. This output is used to further adapt the models using different acoustic, lexical and language models. The outcome of one of more repetitions is finally stored as object 120 in database 12 in which this audio content and documents are embedded with additional video content (not shown), a transcript of the audio content, and further internal side information of the automatic speech recognition process. Some participants might edit or complete this object, as indicated with arrow e.

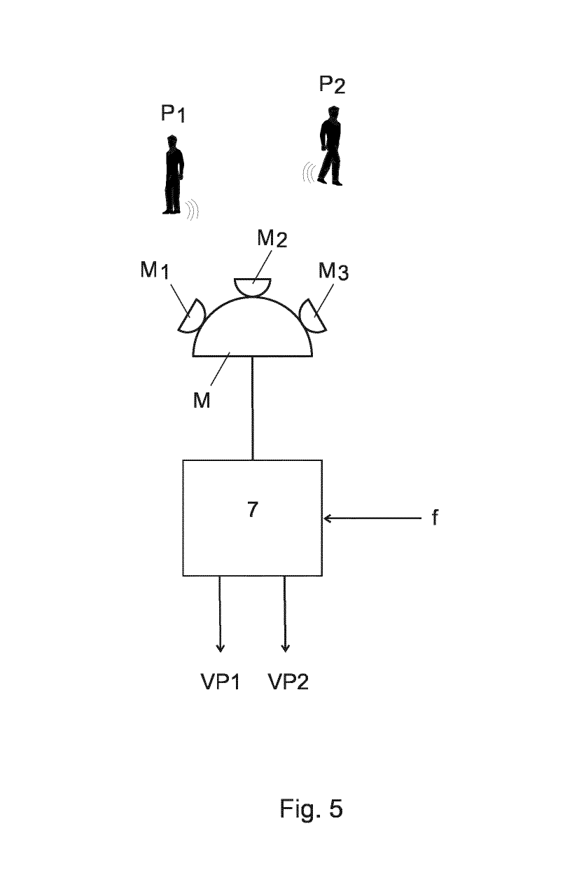

FIG. 5 illustrates an equipment which can be used for audio acquisition in a room with a plurality of participants, for example in a meeting room where participants P1-P2 join in order to establish an online meeting with remote participants. The audio acquisition system comprises an array of microphones M with a plurality of microphones M1 to M3. More microphones in different array configurations can be used. The microphone array M delivers a multi-channel audio signal to a beamforming module 7, for example a hardware or software beamforming module. This beamforming module applies a beamforming conversion, e.g., a linear combination between channels delivered by the various microphones Mᵢ, in order to output one voice signal Vpᵢ for each of the participants Pᵢ, or a compact representation of this voice signal. For example, the beamforming module 7 removes from signal VP1 most audio components coming from participants other than P1, and delivers an output signal VP1 which contains only the voice of this participant. This beamforming module can be used in order to distinguish among several participants in a room, and to deliver to the automatic speech recognition system 1 different audio signals VPi corresponding to different participants in a room.

According to an aspect of the invention, the coefficients of the beamforming module 7 can be adapted based on an output f of the automatic speech recognition system 13. For example, if the automatic speech recognition system detects that at some instant the contribution of different participants are not clearly distinguished, it can modify parameters of the beamforming module in order to improve the beamforming.

The invention concerns also a computer-readable storage medium for performing meeting speech to text transcription, encoded with instructions for causing a programmable processor for performing the described method.

In one or more examples, the functions described may be implemented in hardware, software, firmware, or any combination thereof. If implemented in software, the functions may be stored on or transmitted over as one or more instructions or code on a computer-readable medium. In one preferred embodiment, the method and functions described may be executed as “cloud services”, i.e., through one or several servers and other computer equipment in the Internet, without the user of the method necessarily knowing in which server or computer or at which Internet address those servers or computers are located. Computer-readable media may include computer data storage media or communication media including any medium that facilitates transfer of a computer program from one place to another. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, computers, application specific integrated circuits (ASICs), field programmable logic arrays (FPGAs), or other equivalent integrated or discrete logic circuitry. Different processors could be at different locations, for example in a distributed computing architecture. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

It is to be understood that the claims are not limited to the precise configuration and components illustrated above. Various modifications, changes and variations may be made in the arrangement, operation and details of the methods and apparatus described above without departing from the scope of the claims.

1. A method for providing participants to a multiparty meeting with a transcript of the meeting, comprising the steps of:
establishing an meeting among two or more participants;
exchanging during said meeting voice data as well as documents;
uploading at least a part of said voice data and at least a part of said documents to a remote speech recognition server, using an application programming interface of said remote speech recognition server; converting at least a part of said voice data to text with an automatic speech recognition system in said remote speech recognition server, wherein said automatic speech recognition system uses said documents to improve the quality of speech recognition;
building in said remote speech recognition server a computer object embedding at least a part of said voice data, at least a part of said documents, and said text;
making said computer object available to at least one of said participant.

2. The method of claim 1, further comprising the steps of using words in said document for augmenting a vocabulary used by said automatic speech recognition system.

3. The method of claim 1, wherein said automatic speech recognition system performs a multipass speech recognition where models used during successive passes are changed.

4. The method of claim 1, further comprising the steps of: at a later stage after said meeting, having at least one participant modifying or completing said computer object.

5. The method of claim 4, wherein the modification or amendment to said computer object causes the automatic speech recognition system to perform a new conversion of said voice data to text.

6. The method of claim 4, wherein the modification or amendment to said computer object causes an adaptation of speech and/or language models used by said automatic speech recognition system.

7. The method of claim 1, comprising the step of building a participant-dependant lexicon and/or models based on documents, and using said participant-dependant lexicon and/or models for performing the automatic speech recognition.

8. The method of claim 1, comprising the step of building meeting dependant lexicon and/or models, and using said lexicon and/or models for performing the automatic speech recognition.

9. The method of claim 1, comprising the step of classifying said meeting into at least one class among several classes depending on the topic of the meeting as determined from said
documents, selecting a lexicon depending on said class, and using said lexicon for performing the automatic speech recognition.

10. The method of claim 1, wherein user-authorisations are embedded into said objects for determining which user are authorized to read and/or modify which attribute of the objects.

11. The method of claim 1, further comprising a step of speaker identification and/or speaker location identification for identifying which participant is speaking at each instant, and/or the location of the speaker speaking at each instant.

12. The method of claim 11, wherein a single array of microphone is used for simultaneously recording voice from a plurality of participants to said meeting, wherein a beamforming algorithm is used for said speaker identification.

13. The method of claim 12, further comprising adapting said beamforming based on said documents and/or on said transcript.

14. A computer-readable storage medium, encoded with instructions for causing a programmable processor to perform the method of claim 1.

15. A system for providing participants to a multiparty meeting with a transcript of the meeting, comprising:
a plurality of participants' online equipments comprising a display and an online meeting software for establishing online meetings with other participants, said online meeting comprising exchange of voice and participants' documents;
a speech recognition server arranged for converting the voice of all participants to an online meeting into text using said documents, for generating a transcript of said online meeting including said voice, said text, and said documents, and for making said transcript available to said participants.
